(19) United States
(12) Patent Application Publication
(10) Pub. No.: US 2020/0254463 A1
(43) Pub. Date: Aug. 13, 2020

(54) CENTRIFUGE FILTERS USING A LAYERED, REPLACEABLE MEDIA CARTRIDGE

(71) Applicant: DONALDSON COMPANY, INC., Minneapolis, MN (US)

(72) Inventors: Matthew P. Goertz, Bloomington, MN (US); Eric Paul O'Hara, Minneapolis, MN (US)

(21) Appl. No.: 16/781,282

(22) Filed: Feb. 4, 2020

Related U.S. Application Data
(63) Continuation of application No. 62/802,936, filed on Feb. 8, 2019.

(51) Int. Cl. B04B 5/00; B04B 3/00; B01D 29/07

(52) U.S. Cl. CPC B04B 5/005; B01D 29/073; B04B 3/00

(57) ABSTRACT

A centrifuge system including a centrifuge housing having a cavity at least partially surrounded by an outer shell, a central shaft extending into at least a portion of the cavity, a rotary motion source for rotating the centrifuge housing, and a filter concentrically positioned about the central shaft. The filter includes a first layer adjacent to a second layer, wherein the first and second layers are wound into a roll about a central longitudinal opening. The first layer may include at least one contaminant retention layer and the second layer may include at least one flow defining layer.

### CROSS-REFERENCE TO RELATED APPLICATIONS

This application claims the benefit of U.S. Provisional Patent Application No. 62/802,936 filed Feb. 8, 2019, the entire contents of which are incorporated herein by reference in its entirety.

### TECHNICAL FIELD

The present invention relates to filtration apparatuses, systems, and methods that are typically used in filtering contaminants from fluids, and more particularly relates to filter arrangements that provide for replaceable filter cartridges for use in a centrifuge.

### BACKGROUND

Fluid streams of, for example, fuel, lubricant, or hydraulic oil often carry contaminant material such as dust and other particulates to engines for construction equipment, diesel engines, and the like, such as particulate contaminant that can damage and/or negatively impact the performance of such equipment. In many instances, it is necessary and/or desired to filter some or all of the incoming contaminant material from the fluid stream to protect downstream components from being damaged by contaminants. A number of fluid filter arrangements have been developed for contaminant removal and are often particularly designed to cooperate within certain spaces within or adjacent to the equipment.

In certain engines, centrifuges have been added within the fluid stream in an attempt to remove contaminants such as soot from lube oil to limit or prevent undesirable fuel injection wear, filter plugging, bearing failures, sludge formation, and other engine wear and damage. The basic operation of a centrifuge filter includes the use of a spinning rotor that provides centrifugal force to both a fluid and fluid-borne contaminants. The fundamental concept is that the fluid and contaminants have different densities that allow for selective transport of the contaminant relative to the fluid. This transport allows for damage-causing sludge and contaminants to be removed and clean fluid to be produced. However, it has been found that the use of centrifuges for removing such particles from a fluid stream have extremely low removal efficiency, depending on the particle sizes to be removed and other factors. This is at least partially due to current product designs and the inability of entrained particles to be transported out of the fluid flow stream and consequently retained on filter media. In addition, the distance that contaminants must travel to reach filtration material positioned at the outer edges of a centrifuge can be too large for the size of particles that are to be captured. Thus, there is a need to provide a centrifuge filter with enhanced removal efficiency.

### SUMMARY

In accordance with embodiments of a centrifuge filter described herein, a centrifuge is provided that generally includes a housing, a rotor, and a drive chamber. The rotor and drive chamber are positioned in the housing, and the rotor includes a removable bowl that facilitates cleaning of particles that are removed during the centrifuge process. A drain is provided at the bottom that allows fluid to move to a fluid tank or other location. Enhanced centrifuges as described herein may be useful in cleaning many types of fluids, such as fuel, lubricating oil, hydraulic oil, heat transfer fluid, water, and the like. In more particularity, oil from an engine enters the centrifugal filter body through a hollow spindle that distributes the oil. A removable filter is positioned so that the oil exiting the spindle is directed into it. In an embodiment, the rotor is accelerated to a sufficient speed that creates a centrifugal force to direct the contaminant particles into or onto the filter material. In this way, at least some of the particles are captured by the filter material.

In embodiments of centrifuge filter systems described herein, the acceleration and rotation of the rotor may be caused by oil being sprayed through opposing jets that cause the rotor to spin at a desired speed. In other embodiments, the rotary motion source of a centrifuge can include systems such as a gearbox, transmission, fly wheel, belt system, motor, or the like.

Embodiments of centrifuge systems described herein include a centrifuge housing comprising a cavity at least partially surrounded by an outer shell, a central shaft extending into at least a portion of the cavity, a rotary motion source for rotating the centrifuge housing, and a filter concentrically positioned about the central shaft. The filter comprises a first layer adjacent to a second layer, wherein the first and second layers are wound into a roll about a central longitudinal opening. The first layer may include at least one contaminant retention layer and the second layer may include at least one flow defining layer.

The filter of the centrifuge system may include a top filter surface comprising a first flow face that comprises at least one contaminant retention layer first edge and at least one flow defining layer first edge, and also a bottom filter surface spaced from the top filter surface along a height of the filter, wherein the bottom filter surface comprises a second flow face that comprises at least one contaminant retention layer second edge and at least one flow defining layer second edge. The contaminant retention layer(s) may further include a flow-promoting portion along at least a portion of its length and between the first and second edges of the contaminant retention layer(s). The flow-promoting portion may include at least one aperture, at least one slot, and/or a weakened portion of the contaminant retention layer. In an embodiment, at least a portion of the length of the contaminant retention layer does not comprise a flow-promoting portion.

The central shaft of the centrifuge system may include at least one fluid opening positioned within the central longitudinal opening of the filter. The at least one fluid opening of the central shaft may be positioned adjacent to a flow-promoting portion of the at least one contaminant retention layer.

With regard to the multiple layers of a filter of the centrifuge systems described herein, at least one of the flow defining layers may define at least one fluid flow path in an axial direction as fluid moves from the first flow face toward the second flow face. The at least one flow defining layer may comprise multiple flow defining layers and/or may comprise a mesh material. Similarly, the at least one contaminant retention layer may comprise multiple contaminant retention layers and/or may comprise filtration media that extends from the first flow face to the second flow face.

The at least one flow defining layer may also comprise fibers having a first mean fiber diameter and the at least one contaminant retention layer may comprise fibers having a second mean fiber diameter that is different from the first mean fiber diameter. The first mean fiber diameter of the fibers of the at least one contaminant retention layer may be smaller than a diameter of the second mean fiber diameter of the fibers of the at least one flow defining layer. The at least one flow defining layer may comprise pores having a first mean flow pore size and the at least one contaminant retention layer comprises pores having a second mean flow pore size that is different from the first mean flow pore size. A height in the axial direction of at least one of the flow defining layers may be different from a height of at least one of the contaminant retention layers.

A centrifuge system embodiment may further comprise a fluid flow path extending in the axial direction from the first flow face toward the second flow face. This fluid flow path may be generally parallel to an extending face of at least one of the flow defining layers, and/or the fluid flow path may be generally parallel to an extending face of at least one of the contaminant retention layers.

An embodiment of a filter for use in a centrifuge is provided that includes a first layer adjacent to a second layer, wherein the first and second layers are wound into a roll about a central longitudinal opening, wherein the first layer comprises at least one contaminant retention layer, and wherein the second layer comprises at least one flow defining layer. The filter further includes a top filter surface comprising a first flow face that comprises at least one contaminant retention layer first edge and at least one flow defining layer first edge, and a bottom filter surface spaced from the top filter surface along a height of the filter. The bottom filter surface may comprise a second flow face that comprises at least one contaminant retention layer second edge and at least one flow defining layer second edge, and the at least one contaminant retention layer may comprise a flow-promoting portion along at least a portion of its length and between the first and second edges of the at least one contaminant retention layer.

An embodiment of a filter for use in a centrifuge includes a first layer adjacent to a second layer, wherein the first and second layers are wound into a roll about a central longitudinal opening, wherein the first layer comprises at least one contaminant retention layer, and wherein the second layer comprises at least one flow defining layer, and wherein the at least one contaminant retention layer comprises a flow-promoting portion along at least a portion of its length and between the first and second edges of the at least one contaminant retention layer. The filter further includes a top filter surface comprising a first flow face that comprises at least one contaminant retention layer first edge and at least one flow defining layer first edge, and a bottom filter surface spaced from the top filter surface along a height of the filter. The bottom filter surface comprises a second flow face that comprises at least one contaminant retention layer second edge and at least one flow defining layer second edge. A first side of the flow-promoting portion comprises a third flow face, and a second side of the flow-promoting portion comprises a fourth flow face.

### BRIEF DESCRIPTION OF THE DRAWINGS

The present invention will be further explained with reference to the appended Figures, wherein like structure is referred to by like numerals throughout the several views, and wherein;

FIG. 1 is a cross-sectional side view of an embodiment of an exemplary centrifuge including a removable and replaceable filter positioned therein;

FIG. 2 is a perspective view of a centrifuge housing in which an exemplary removable and replaceable filter is positioned;

FIG. 3 is a perspective view of an exemplary embodiment of a centrifuge filter with a portion of its outer filter material unwound from a roll of filter material;

FIG. 4 is another perspective view of an embodiment of a centrifuge filter of the type illustrated in FIG. 3;

FIG. 5 is a top view of a portion of an exemplary embodiment of filter material of the type used in the centrifuge filters of FIGS. 3 and 4, for example;

FIG. 6 is a cross sectional side view of an embodiment of an exemplary centrifuge including a removable and replaceable filter positioned therein; and

FIG. 7 is a graph of illustrating the improvement in particle removal efficiency for layered media as compared to traditional paper liner control.

### DETAILED DESCRIPTION

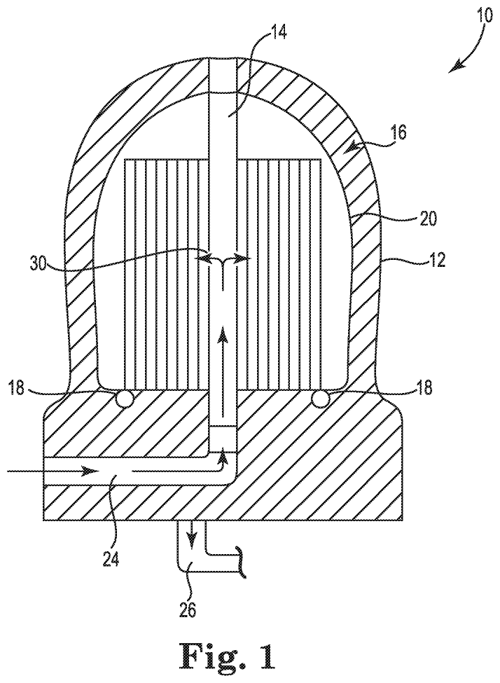

Referring now to the Figures, wherein the components are labeled with like numerals throughout the several Figures, and initially to FIG. 1, a centrifuge 10 is provided that generally includes an outer housing 12, a central shaft 14 and a rotor assembly 16. The rotor assembly includes a removable bowl 20 that facilitates cleaning of particles that are removed from a contaminated fluid during a centrifuge process. A removable and replaceable filter 22 is concentrically positioned relative to the central shaft 14, which will be described below in further detail. The centrifuge 10 is provided with an input tube or shaft 24 into which contaminated fluid (e.g., oil) can enter the system for filtering. A drain 26 is provided at the bottom of centrifuge 10 that allows fluid to move to a sump or other area for further use of the exiting fluid after it has been filtered.

The central shaft 14 includes at least a portion that is hollow and includes at least one aperture 30 through which fluid can exit during the centrifuge filtering process. In this embodiment, multiple apertures 30 are provided at an intermediate position along the length of shaft 14, such that fluid is forced upwardly through the shaft 14 and into the filter 22 through these apertures 30. Removable filter 22 is positioned so that oil or other contaminated fluid exiting the shaft is directed toward the face of the filter material in a generally perpendicular direction, although at least portions of the fluid can exit at non-perpendicular angle to the face of the filter material.

The rotor assembly 16 is accelerated to a sufficient speed to create a centrifugal force that further directs or forces the contaminated fluid outwardly through the filter material. The acceleration of the rotor assembly 16 can be caused by oil sprayed through opposing nozzles 18 that cause the rotor assembly 16 to spin at a desired speed, although rotation of the rotor assembly 16 can instead be accomplished using one nozzle, more than two nozzles, and/or other methods. When an even number of nozzles 18 are used, they can be symmetrically positioned on opposite sides of the central shaft 14 such that their corresponding flow directions are opposite each other. In this way, the nozzles 18 create a driving force to rotate the rotor assembly 16 about the central shaft 14 within the housing 12.

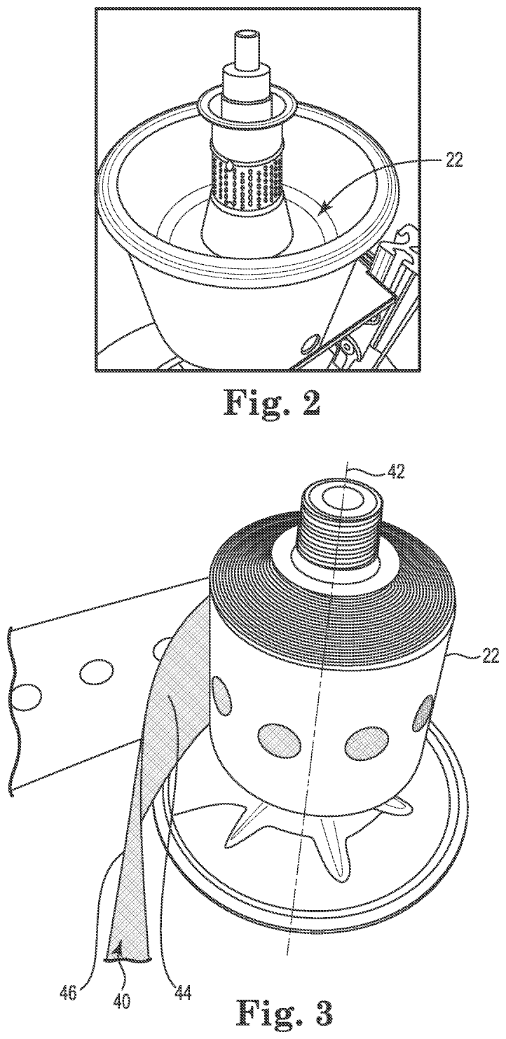

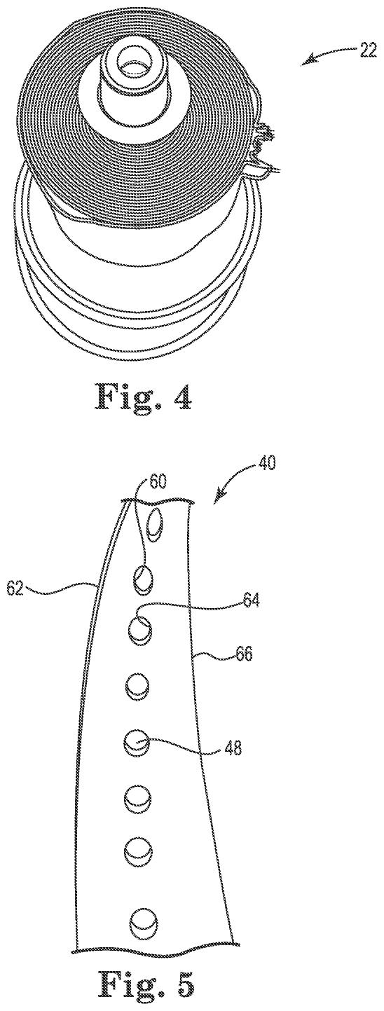

Referring also to FIGS. 2-5, an exemplary embodiment of filter 22 is illustrated, which includes filter material 40 wound into a rolled configuration about a central longitudinal axis 42. Filter material 40 includes at least one flow defining layer 44 and at least one contaminant retention layer 46 arranged in a rolled configuration about central longitudinal axis 42. In this illustrated embodiment, the flow defining layer 44 is immediately adjacent to contaminant retention layer 46, and the pair of layers is rolled either about itself or around a core that extends along the longitudinal axis 42 to create a cylindrical filter. Either or both of the layers 44, 46 can include a single-layer structure or can be a multi-layer structure.

The contaminant retention layer 46 can further include a weakened area or flow-promoting portion along its height, such as is illustrated in FIGS. 3-5 as multiple apertures or perforations 48. In an embodiment, the apertures or perforations 48 in the contaminant retention layer 46 are provided in the area that is closer to the central longitudinal axis 42, but such apertures or perforations 48 are not present in the area further from the axis 42 (i.e., at the area closer to the outside of the filter 22 or the “outer wraps” of the rolled filter material). The number of layers that include the perforations or apertures 48 can vary, wherein an exemplary embodiment includes perforations or apertures 48 for more than half of the overall length of the contaminant retention layer 46, while the remainder of the length of the layer 46 can be considered to be free of such perforations or apertures. However, the percentage of the length of the contaminant retention layer 46 that has perforations or apertures versus the portion that does not have such flow-promoting features can vary considerably.

In an exemplary embodiment, the perforations or apertures 48 can be positioned so that they are generally adjacent the area where fluid exits apertures 30 in the shaft 14. In this way, fluid exiting the apertures 30 in the shaft 14 will move relatively easily outwardly with the centrifugal force through the apertures or perforations 48 and toward the area in which the contaminant retention layer 46 does not include such perforations and is generally a more “solid” sheet of filter material. Once the fluid reaches these layers, fluid can flow from the central area of the rolled layers to the bottom and/or top of the rolled layers across the rolled faces of the flow defining layer 44 and contaminant retention layer 46.

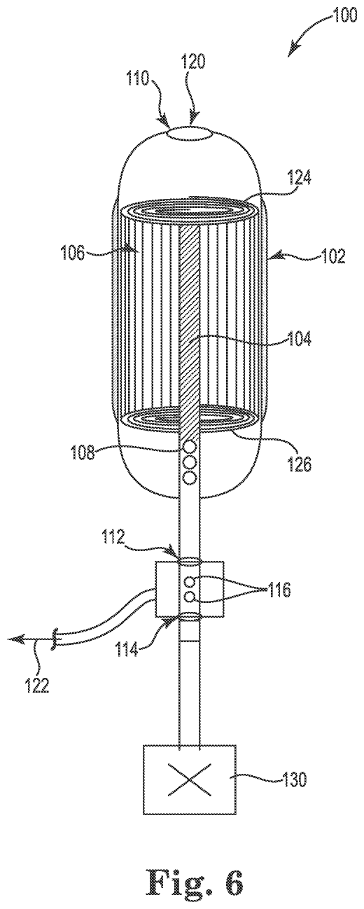

The apertures or perforations 48 can have a wide variety of configurations, such as openings of the same size that are spaced from each other with a generally uniform spacing along the length of the filter material. Alternatively, the apertures or perforations 48 can include openings that are differently sized along the length of the filter material and/or can be spaced at varying space intervals along the length of the filter material. The apertures or perforations 48 can be aligned with each other, such as shown in FIG. 5, for example. In this way, the apertures or perforations will be similarly spaced from the edges of the filter material when in a rolled configuration, wherein at least some of the apertures or perforations 48 can thereby overlap or align with each other in the roll. Alternatively, the apertures or perforations 48 can be spaced differently from the edges of the filter material such that they will not overlap or may only partially overlap each other when arranged in a rolled configuration. In addition, although the apertures or perforations 48 are shown as circular, the apertures or perforations 48 can have a wide variety of shapes, such as oval, square, rectangular, irregular, or the like.

It is also understood that the apertures or perforations 48 can instead be replaced with a slot or gap that extends along at least a portion of the length of the filter material. In this and other exemplary embodiments, there can be more than one strip or section of apertures or perforations spaced from each other along the height of the rolled filter material. In such cases, additional openings can be provided in the central shaft 14 through which contaminated liquid can exit.

Rolled filters that include filter materials arranged in accordance with embodiments described herein can be referred to as “flow-by” filters, which are structured with at least two kinds of material layers arranged in, for example, a rolled configuration as described above and in International Patent Application No. PCT/US2018/045918, the entire contents of which are incorporated herein by reference. These filters provide for relatively constant removal efficiency for many types and sizes of contaminants and/or particles. The flow-by filters also exhibit efficiency decreases during contaminant loading, and the differential pressure change is minimal throughout loading. However, the clean media pressure drop is relatively high. Combining the performance characteristics described for flow-by filters provide for many possible application scenarios that can benefit from this filtration configuration. It is contemplated that filters of the invention can be used for filtration of a wide variety of different substances via a centrifuge configuration, such as fuel, water, air, or the like, and can capture a wide variety of particulate and/or droplet contaminants.

In more particularity, “flow-by” filtration described herein involves material containing contaminant that flows through the filter and is directed generally parallel to the planar surface (e.g., top and bottom surfaces) of multiple layers of filter media so that the material flows “by” the surface of the filter media rather than through it. Such an arrangement is generally perpendicular to traditional filter arrangements in which fluid flows directly through the pore structure of the filter media (i.e., through the thickness of the filter media, such as from a top planar surface to a bottom planar surface).

In the flow-by filter configurations of the invention, multiple layers of material are arranged in a roll such that the edges of the layers lie generally in the same plane, which is referred to herein as a flow face. Such a flow face is a surface defined by the edges of the layers, wherein this flow face is generally perpendicular to the direction in which material will flow relative to the outer layers of the roll and is located where the material enters and/or exits the roll of filter material. Embodiments of this flow face can comprise the edges of multiple layers, wherein all of the layer edges may be aligned with each other or a flow face may instead include an irregular surface made up of staggered edges of layers.

With particular reference to the filter material 40 of FIG. 5 with apertures or perforations 48 through the contaminant retention layer 46, contaminant retention layers 46 may be described as extending from an inner surface 60 of each of these openings 48 to an edge surface 62, which is the closest free edge surface of the material to that side of the opening, and also as extending from an opposite side 64 of the inner surface of each of these openings 48 to an edge surface 66.

Adjacent to one side of the contaminant retention layer is flow defining layer 44 which includes a first face surface and an opposite second face surface. The flow defining layers 44 are used to define a flow path through the roll of filter material. Each flow defining layer 44 includes a first or top edge and a second or bottom edge opposite the first edge. Each flow defining layer 44 also includes a first face surface and an opposite second face surface. The two distinct layers 44, 46 having differing fiber constructions are utilized for their individual roles in the composite structure of the filter roll. That is, the flow defining layers 44 perform the function of defining a flow path through the filter, while the contaminant retention layers 46 perform the function of retaining or capturing contaminants that are transported to its pore structure, such as contaminants in a liquid.

Although it is not required, in order to maximize the filtration performance of the filter rolls of the invention, the edges of the flow defining layers and the contaminant retention layers are generally aligned with each other in each roll. In certain embodiments, the roll will generally fill the housing or other structure of the centrifuge or other equipment in which it is positioned in order to maximize the amount of material available for filtration in a given volume. However, other embodiments may include layers of different sizes and/or shapes so that the edges of the various layers can be staggered in an ordered or random arrangement along the height of the roll. In any of the arrangements where the edges of the layers are not aligned, the flow face will still comprise the edges of the layers facing the direction in which material flow is entering or exiting the filter roll.

The flow defining layers 44 can be configured as a mesh or screen type of structure having relatively large intersecting fibers or strands, as compared to the fibers in the contaminant retention layers. The relatively large fibers and corresponding large pores of the flow defining layers contribute to the composite flow permeability. Although the flow-by filter properties discussed herein are configured so that contaminated material flows generally across the surfaces of the multiple layers, the size of the pores or openings are measured or sized lateral to the direction of flow (i.e., the flow-through direction). That is, the pore size is measured and selected to provide desired flow characteristics, even though the filter is not arranged for material to flow through the thickness of the filter material.

The contaminant retention layers 46 can be configured as a mesh or screen type of structure having relatively small intersecting fibers or strands, as compared to the fibers in the flow defining layers. Holes or openings that are created by these intersecting strands may be referred to as pores. The pores sizes are designed or selected with consideration of the size of the contaminants to be captured by the particular contaminant retention layer. Alternatively, the contaminant retention layers may be made from materials that do not have a mesh or screen type structure but still include pores or openings to allow for flow while the area surrounding the openings can catch or stop the contaminants.

FIG. 6 illustrates another embodiment of a centrifuge 100 that includes an outer housing 102, a central shaft 104, and an external source of external rotary motion 130. A removable and replaceable filter 106 is concentrically positioned relative to the central shaft 104. The filter 106 includes a top area or surface 124 and a bottom area or surface 126. The centrifuge 100 is provided with an input area 120 into which contaminated fluid (e.g., oil) can enter the system for filtering. A drain 122 is provided at the bottom of centrifuge 100 that allows fluid to move to a sump or other area for further use of the exiting fluid after it has been filtered.

The central shaft 104 includes at least a portion that is hollow and includes at least one aperture 108 positioned within the outer housing 102 below the bottom 126 of the filter 106. The shaft 104 also includes at least one aperture 116 below the bottom of the outer housing 102, which can exit into a vessel or other container. In operation, contaminated fluid moves into the housing 102 from the input area 120 to the top 124 of the filter 106 while the centrifuge 100 is operating. The contaminated fluid moves through the filter 106 toward the bottom 126 of the filter 106, wherein contaminants will be captured by the filter 106 during this movement such that filtered fluid will exit from the bottom 126 of the filter 106. Filtered fluid then enters the one or more apertures 108 and moves toward the one or more apertures 116 through which fluid can exit during the centrifuge filtering process, such as through the outlet 122.

In this embodiment of centrifuge 100, the rotary motion of the filter 106 is not derived from opposing oil jets, as discussed above relative to centrifuge 10 of FIG. 1, but from another source of rotation, which is represented by the rotary motion source 130. Rotary motion source 130 can include systems such as a gear box, transmission, fly wheel, belt system, a motor, or the like. The contaminated fluid enters the rotating vessel through inlet located at inlet area 120, which can be connected by a rotary seal 110. Fluid then flows into the filter 106 at the top 124, which also may be referred to as a first flow face, then through the length of the filter 106. Fluid exits at the filter 106 at the bottom 126, which may also be referred to as a second or opposing flow face.

The materials that make up the filter, which can include any of the filter materials and configurations discussed herein, are wound around a center spindle that is hollow to allow for fluid transport. The holes 108 allow for acceptance of filtered fluid released from the filter 106, as discussed above. The filtered fluid flows through the hollow tube and exits through the holes on a stationary (non-rotating) vessel that is connected through two rotary seals 112, 114. In this embodiment, the direction of fluid flow could be reversed for a given application/design. The outer housing 102 is sealed against the outermost wraps of the filter 106 to prevent flow from bypassing the filter media. The outer housing 102 may also include structures and features that allow for easy removal/replacement of the filter 106.

In general for various embodiments of the filter rolls, the pore sizes of the flow defining layer, when measured in the flow through orientation using the above described capillary flow porometry and/or other techniques, are greater than the sizes of the pores of the contaminant retention layer (also measured in the flow through direction). In certain embodiments, the sizes of the pores of the contaminant retention layer are in the range of 0.1-200 microns measured in the flow through orientation, but can more specifically be in the range of 0.5-500 microns, more specifically 1-100 microns, or more specifically 1-20 microns.

In certain embodiments, the thicknesses of the flow defining layers are in the range of 100-5000 microns measured in the flow through orientation, but can more specifically be in the range of 500-2000 microns, or more specifically 500-1000 microns. The thickness of each of the flow defining layers is selected to provide desired performance for the filter rolls, in that flow defining layers that are too thin will provide too much resistance (low permeability) and flow defining layers that are too thick will exhibit unacceptably low capture efficiency for a particular application. Thus, it is desired to select flow defining layers that optimally align with the most important desired parameters for a particular filtration application.

Filter embodiments of the invention can be provided with filtration zones of varying permeability to provide desired filtration performance. In such embodiments, the permeability of the filtration material will be measured from one flow face to the other, although the permeability can vary in any direction relative to the roll. For example, the permeability may be constant across the width of a roll, but increase or decrease when moving from flow face to flow face of a roll. In an alternative example, the permeability may instead vary across the width of a roll. Other variations of permeability zones are also contemplated and designed to provide desired filtration performance.

Many alternatives to the flow defining layers are contemplated and considered to be within the scope of the embodiments described herein. In one exemplary embodiment of the flow defining layer, the layer is not provided with continuous strands but instead includes a patterned structure such as dots, dimples, craters, and/or other raised or recessed structures arranged in a patterned grid. In another exemplary embodiment of the flow defining layers, the layers are provided with a completely random or partially random arrangement of dots, dimples, craters, and/or other raised or recessed structures across the face of the flow defining layers.

The contaminant retention layers are generally configured to be able to capture contaminant or particles as material flows generally by or past their first and second face surfaces. However, because the materials from which the contaminant retention layers are made can comprise multi-fiber material formed into a sheet or layer, the face surfaces can be textured in such a way that contaminants will contact the fibers as the fluid flows past the surface. As with the flow defining layers, the choice of filter material for a contaminant retention layer can be selected to provide desired performance characteristics for the filter.

With any of the embodiments described herein, the filters of the invention can include flow defining layers and alternating contaminant retention layers such that there is an approximate 1:1 ratio of the different types of layers in a filter configuration. In other embodiments of the invention, the ratio can be different, such as providing a 2:1 or different ratio of flow defining layers to contaminant retention layers or providing a 2:1 or different ratio of contaminant retention layers to flow defining layers. It is further contemplated that an embodiment of the invention includes no flow-defining layers, but that fluid flow is still directed along the faces of the contaminant retention layers.

While the above description of embodiments of centrifuge systems that utilize the rolled filter embodiments described herein, it is understood that the rolled filter elements can be configured and sized to fit into other conventional centrifuge assemblies, such as those that are commercially available for use in removing contaminants using known centrifuge techniques. In such cases, the location of any apertures or perforations may or may not be adjusted relative to openings through which contaminated liquid exits from a central shaft, for example.

The operation of the present invention will be further described with regard to the following example. This example is offered to further illustrate various embodiments and techniques. It should be understood, however, that many variations and modifications may be made while remaining within the scope of the present description.

The example provided herein relates to the addition of a layered media pack or roll to an empty bowl centrifuge. The filter shown in FIGS. 3-5 was created by co-wrapping several layers of a contaminant retention layer and a flow defining layer about a central core or axis. In this example, the contaminant retention layer is 4-micron material commercially available from Donaldson Company Inc. of Minneapolis, Minn. under the trade designation “SYNTEQ XP (4)CP).” The flow defining layer is a polypropylene mesh part number 3792, available from Naltex of Austin, Tex. The layers were wound around a hollow core to form 15 wraps of both layers together, followed by 5 layers of only the contaminant retention layer. The first 15 wraps of the contaminant retention layer have a ¾″ diameter hole punched into the center that repeats along the wrapped direction every 1″. The edge of these holes forms the entry flow face for the media pack and is aligned with the flow port in the centrifuge spindle. The total height of the media pack is 3″ and was placed inside of a Spinner II model 936 oil powered centrifuge available from T.F. Hudgins Company of Houston, Tex.

The performance of the layered media pack was compared to the performance of a Spinner II centrifuge with a traditional paper liner placed in the rotating bowl. Testing utilized a multipass hydraulic fluid filtration bench produced by Bonavista technologies of Tulsa, Okla. The filtration tests used Mil-5606 hydraulic fluid containing ISO 12103-1, A3 medium test dust passing through the test fixture at 3.6 liters per minute with a fluid sump volume of 8 liters. Contaminant removal efficiency was measured by injecting 4 grams of test dust into the sump and recirculating through the filter for 1 hour. Samples were pulled at various time points and particle counted according to ASTM D7647-10(2018).

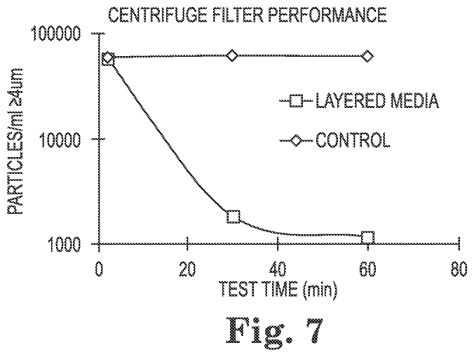

FIG. 7 illustrates the improvement in particle removal efficiency for layered media pack as compared to the traditional paper liner control for the example discussed above. Recirculation of the contaminant through the test device for 1 hour shows a particle removal efficiency of 98% for all particles larger than 4 microns when the layered media pack is used. In comparison, the same test produces a <1% removal efficiency for the traditional paper liner.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. A centrifuge system comprising:
a centrifuge housing comprising a cavity at least partially surrounded by an outer shell;
a central shaft extending into at least a portion of the cavity;
a rotary motion source for rotating the centrifuge housing; and
a filter concentrically positioned about the central shaft, the filter comprising a first layer adjacent to a second layer, wherein the first and second layers are wound into a roll about a central longitudinal opening.

2. The centrifuge system of claim 1, wherein the first layer comprises at least one contaminant retention layer and wherein the second layer comprises at least one flow defining layer.

3. The centrifuge system of claim 2, wherein the filter comprises:
a top filter surface comprising a first flow face that comprises at least one contaminant retention layer first edge and at least one flow defining layer first edge; and
a bottom filter surface spaced from the top filter surface along a height of the filter, wherein the bottom filter surface comprises a second flow face that comprises at least one contaminant retention layer second edge and at least one flow defining layer second edge.

4. The centrifuge system of claim 3, wherein the at least one contaminant retention layer comprises a flow-promoting portion along at least a portion of its length and between the first and second edges of the at least one contaminant retention layer.

5. The centrifuge system of claim 4, wherein the flow-promoting portion comprises at least one aperture.

6. The centrifuge system of claim 4, wherein the flow-promoting portion comprises a weakened portion of the contaminant retention layer.

7. The centrifuge system of claim 4, wherein at least a portion of the length of the contaminant retention layer does not comprise a flow-promoting portion.

8. The centrifuge system of claim 1, wherein the central shaft comprises at least one fluid opening positioned within the central longitudinal opening of the filter.

9. The centrifuge system of claim 8, wherein the at least one fluid opening of the central shaft is positioned adjacent to a flow-promoting portion of the at least one contaminant retention layer.

10. The centrifuge system of claim 2, wherein the at least one flow defining layer comprises a mesh material.

11. The centrifuge system of claim 3, wherein the at least one contaminant retention layer comprises filtration media that extends from the first flow face to the second flow face.

12. The centrifuge system of claim 2, wherein the at least one flow defining layer comprises fibers having a first mean fiber diameter and the at least one contaminant retention layer comprises fibers having a second mean fiber diameter that is different from the first mean fiber diameter.

13. The centrifuge system of claim 2, wherein the at least one flow defining layer comprises pores having a first mean flow pore size and the at least one contaminant retention layer comprises pores having a second mean flow pore size that is different from the first mean flow pore size.

14. The centrifuge system of claim 3, further comprising a fluid flow path extending in the axial direction from the first flow face toward the second flow face.

15. The centrifuge system of claim 14, wherein the fluid flow path is generally parallel to an extending face of at least one of the flow defining layers.

16. The centrifuge system of claim 14, wherein the fluid flow path is generally parallel to an extending face of at least one of the contaminant retention layers.

17. The centrifuge system of claim 2, wherein a height in the axial direction of at least one of the flow defining layers is different from a height of at least one of the contaminant retention layers.

18. The centrifuge system of claim 1, wherein the rotary motion source comprises at least one of opposing jets, a gearbox, a transmission, a fly wheel, a belt system, and a motor.

19. A filter for use in a centrifuge, the filter comprising:
a first layer adjacent to a second layer, wherein the first and second layers are wound into a roll about a central longitudinal opening, wherein the first layer comprises at least one contaminant retention layer and wherein the second layer comprises at least one flow defining layer;
a top filter surface comprising a first flow face that comprises at least one contaminant retention layer first edge and at least one flow defining layer first edge; and
a bottom filter surface spaced from the top filter surface along a height of the filter, wherein the bottom filter surface comprise a second flow face that comprises at least one contaminant retention layer second edge and at least one flow defining layer second edge;
wherein the at least one contaminant retention layer comprises a flow-promoting portion along at least a portion of its length and between the first and second edges of the at least one contaminant retention layer.

20. A filter for use in a centrifuge, the filter comprising:
a first layer adjacent to a second layer, wherein the first and second layers are wound into a roll about a central longitudinal opening, wherein the first layer comprises at least one contaminant retention layer and wherein the second layer comprises at least one flow defining layer, and wherein the at least one contaminant retention layer comprises a flow-promoting portion along at least a portion of its length and between the first and second edges of the at least one contaminant retention layer;
a top filter surface comprising a first flow face that comprises at least one contaminant retention layer first edge and at least one flow defining layer first edge;
a bottom filter surface spaced from the top filter surface along a height of the filter, wherein the bottom filter surface comprise a second flow face that comprises at least one contaminant retention layer second edge and at least one flow defining layer second edge;
a first side of the flow-promoting portion comprising a third flow face; and
a second side of the flow-promoting portion comprising a fourth flow face.
